(19) United States
(12) Patent Application Publication
(10) Pub. No.: US 2014/0357365 A1
(43) Pub. Date: Dec. 4, 2014

(54) Electronic Game Personalization

(71) Applicant: Empire Technology Development LLC, Wlimington, DE (US)

(72) Inventor: Ezekiel Kruglick, Poway, CA (US)

(73) Assignee: Empire Technology Development LLC, Wilmington, DE (US)

(21) Appl. No.: 14/344,795

(22) PCT Filed: Jun. 4, 2013
(86) PCT No.: PCT/US13/44159

§ 371 Date: Mar. 13, 2014

(51) Int. Cl. A63F 13/30

(52) U.S. Cl. CPC A63F 13/12; A63F 2300/6027
USPC 463/31

(57) ABSTRACT

Technologies are generally described for personalizing an electronic game. In some examples a method for personalizing an electronic game may include intercepting content, extracting particular content from the intercepted content, and personalizing the electronic game based on the extracted content.

### BACKGROUND

Unless otherwise indicated herein, the approaches described in this section are not prior art to the claims in this application and are not admitted to be prior art by inclusion in this section.

Conventional electronic game systems personalize game environments by categorizing a user into 3-4 behavioral bins, which requires extensive in-game observation data before predictions can be made. Conventional electronic game systems do not customize user experience based on information about a user's real world experiences.

### SUMMARY

According to some examples, a method is provided for personalizing an electronic game. The method may include intercepting content, extracting particular content from the intercepted content, and personalizing the electronic game based on the extracted content.

According to other examples, a machine readable non-transitory media may store therein instructions to personalize an electronic game. that the instructions may, when executed by one or more processors, operatively enable an electronic game experience module (EGEM) to intercept text based information directed towards a user, extract particular words from the text based information, and personalize the electronic game based at least in part on the extracted particular words.

According to further examples, a system is provided to personalize an electronic game. The system may include a processor and an electronic game experience module (EGEM) communicatively coupled to the processor, the EGEM configured to intercept text based information directed towards a user, extract particular words from the text based information, and personalize the electronic game based at least in part on the extracted particular words.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will be described with additional specificity and detail through use of the accompanying drawings.

In the drawings:

FIG. 1 illustrates a block diagram of an example system that can be utilized to personalize an electronic game;

FIG. 2 illustrates a block diagram of an example system that can be utilized to personalize an electronic game;

FIG. 3 illustrates a block diagram of an example system that can be utilized to personalize an electronic game;

FIG. 4 illustrates a flow diagram of an example process for personalizing an electronic game;

FIG. 5 illustrates an example computer program product for personalizing an electronic game; and

FIG. 6 illustrates a block diagram of an example computing device, all arranged in accordance with at least some embodiments described herein.

### DETAILED DESCRIPTION

The following description sets forth various examples along with specific details to provide a thorough understanding of claimed subject matter. It will be understood by those skilled in the art that claimed subject matter may be practiced without some or more of the specific details disclosed herein. Further, in some circumstances, well-known methods, procedures, systems, components and/or circuits have not been described in detail, in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

This disclosure is drawn, inter alia, to technologies including methods, devices, systems and computer readable media related to a personalization system for electronic games including Massive Multi-player Online Games (MMOGs), online games, video games and/or the like. In one example, a user may connect a content source such as email and/or content feeds to processing modules that extract subject material and use game asset search capabilities to increase the frequency of occurrence of game material personally relevant to the particular user while using personal content sentiment analysis to filter negatively associated material. As used herein, “user” generally refers to a player of an electronic game, and the terms “user” and “player” are to be understood to have the same meaning and are used interchangeably herein. The terms “intercept,” “intercepting,” and/or “intercepted” as used herein may refer to authorized and/or unauthorized referencing of, for example, content.

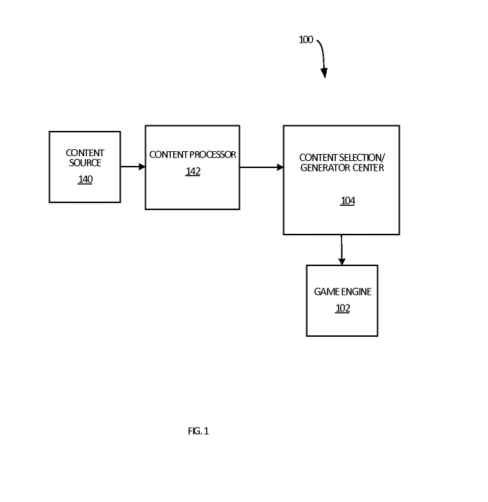

FIG. 1 is a block diagram illustrating an example system 100 that can be utilized to personalize an electronic game, arranged in accordance with at least some embodiments described herein. As depicted, system 100 may comprise a content source 140 associated with a particular user. Content source 140 may send content to a content processor 142 to be processed. The content may comprise text, images, audio, video and/or the like. The content may derive from email communications, instant messaging communication, SMS communications, social media, rich site summary (RSS) feed content, news alerts, Internet content and/or the like.

In one example, content processor 142 may be configured to extract content based on a variety of analysis techniques including keyword search, semantic analysis, sentiment analysis, natural language analysis, terminology extraction, terminology mining, term extraction, term recognition, glossary extraction and/or the like. Content processor 142 may be configured to associate extracted content with positive and/or negative sentiment corresponding with the particular user. The positive and/or negative sentiment may be measured by any metric such as in degrees or along a continuum. In some examples, extracted content may not be associated with sentiment.

In one example, content processor 142 may communicate extracted content to content selection/generator (CSG) center 104. CSG center 104 may be an electronic game experience module (EGEM) server and may be configured to map electronic game assets to extracted content to identify relevant and/or sentiment sensitive electronic game assets. Electronic game assets may comprise a variety of electronic game content variables available for use and/or display during play of an electronic game such as characters, scenes, powers, weapons, motifs, themes, props, advertisements, rewards, remunerations, audio, video, images, and/or the like. CSG center 104 may communicate the identified relevant and/or sentiment sensitive electronic game assets to game engine 102. Game engine 102 may be configured to include the identified relevant and/or sentiment sensitive electronic game assets in an electronic game associated with the particular user. In an example, an electronic game environment at be personalized based on the identified relevant and/or sentiment sensitive electronic game assets. An electronic game environment may comprise at least one of scenery, background, character, mood, or interaction of the electronic game.

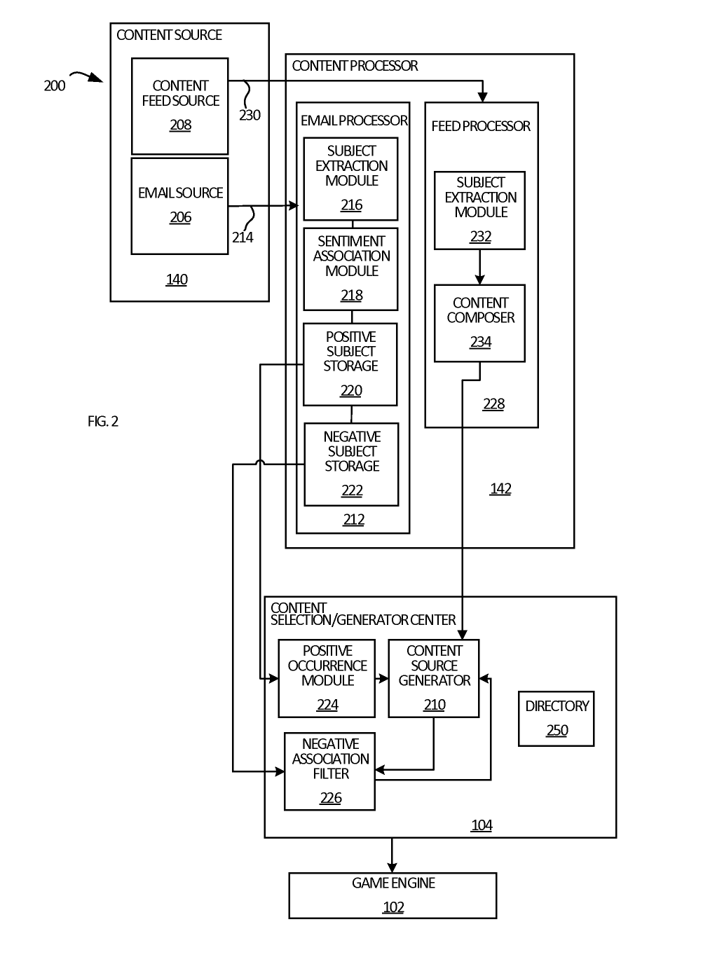

FIG. 2 is a block diagram illustrating an example system 200 that can be utilized to personalize an electronic game, arranged in accordance with at least some embodiments described herein. As depicted, system 200 may comprise content source 140 associated with a particular user. Content source 140 may include any of a variety of content resources such as email source 206 and/or content feed source 208. Email source 206 and/or content feed source 208 may make available email and/or feed content to content processor 142. Content processor 142 may be configured to identify and/or extract particular content from email and/or feed content. The particular content may be relevant and/or sentimental to the particular user and an association between the particular user and the particular content may be established. CSG center 104 may be configured to receive the particular content from content processor 142 and may map the particular content to the particular user and to electronic game content. CSG center 104 may select one or more electronic game assets for customizing an electronic game for the particular user based on the association with the particular content. CSG center 104 may send or identify the selected electronic game assets to a game engine 102 for personalizing an electronic game associated with the particular user by custom assembly and display of the electronic game incorporating the selected electronic game assets.

In one example, content processor 142 may comprise an email processor 212 configured to receive email content associated with the particular user or user terminal via an email connection 214. Email connection 214 may be set-up and/or authorized by a user playing an electronic game, such as an online game, video game and/or MMOG via any number of authentication mechanisms. For example, a third party authentication service may provide a method for users to authorize a third-party to access server resources without sharing authentication credentials (e.g., a username and password), via user-agent redirections. One such third party resource is OAuth 2.0. OAuth 2.0 permits clients to access server resources on behalf of a resource owner.

In one example, subject extraction module 216 may process email content and choose particular email content for extraction by a variety of methods such as key word searching, semantic analysis, and/or natural language processing to extract: keywords, sentiments, entities, relations, locations, emotions, or associations and other properties from email content. Based on one or more analyses, subject extraction module 216 may select content for extraction such as text, audio, video and/or images from the email communications. The extracted content may be selected to be relevant and/or sentimental to the particular user.

In one example, the extracted content may be analyzed at sentiment association module 218 and separated into subjects that are associated with positive or negative sentiments for the purposes of electronic game content. Sentiment association analysis may be available as a service from a variety of sources. In an example, sentiment association analysis may operate by calculating a posterior probability that the expressive language and/or other content used is associated with typical different sentiment corpora. Sentiment association module 218 may process text, audio, video and/or image data extracted from an email communication to identify subjects and/or content that are relevant and/or sentimentally positive or negative to the particular user. Positive sentiment subjects may be identified by sentiment association analysis and stored in positive subject storage 220. Likewise, negative sentiment subjects may be identified by sentiment association analysis and stored in negative subject storage 222.

In one example, positive sentiment subjects may be communicated from positive subject storage 220 to positive occurrence module 224. Positive occurrence module 224 may map positive sentiment subjects with associated electronic game assets. The mapped electronic game assets may be identified as “positive” electronic game assets based on the mapping. Electronic game assets such as scenery, background, character, mood, interaction of the electronic game, various game environments, challenges, players, avatars, themes, props, images, audio, video and the like may be associated with one or more sentiment subjects in a directory 250 stored in CSG center 104. Directory 250 may be accessed to identify positive sentiment subjects to identify electronic game assets that may be associated and/or mapped to the positive sentiment subjects.

In one example, CSG center 104 may comprise a content source generator 210 configured to generate an electronic game experience from plot templates to mix-and-match characters, goals, and/or details to personalize an electronic game experience based on the mapping of electronic game assets to positive sentiment and/or relevant subjects.

In one example, negative sentiment subjects may be communicated from negative subject storage 220 to negative association filter 226. Content source generator 210 may communicate content source generator output, including “positive” electronic game assets, to negative association filter 226. Negative association filter 226 may filter negative sentiment subjects from the content source generator output and reclassify particular “positive” electronic game assets as “negative” electronic game assets to be avoided in personalizing the electronic game. The identification may be based on directory 250 mapping of electronic game assets and sentiment subjects. Positive electronic game content impacted by negative association filter 226 may be communicated back to content source generator 210 which may replace one or more electronic game assets removed by negative association filter 226.

In one example, a feed processor 228 may receive a content feed associated with a particular user via feed connection 230 from content feed source 208. Feed connection 230 may be authorized and/or authenticated by a variety of methods such as via a third party authentication service. A subject extraction module 232 may process and extract feed content by a variety of methods such as key word searching, subject extraction, semantic analysis, and natural language processing to extract: keywords, sentiments, entities, relations, and/or the like. In an example, content extracted from the feed content may be provided to a content composer 234. Content composer 234 may associate extracted feed content with the particular user. Content composer 234 may use extracted feed content to generate relevant content concepts to be used by content source generator 210 to select relevant electronic game assets. Content composer 234 may communicate content concepts to content source generator 210. Based on content concepts and/or feed content, content source generator 210 may search for relevant electronic game content assets such as related characters and objects. Content source generator 210 may fill in goal or ambiance descriptions with: items or events identified in the extracted feed content, randomly generated content, pre-generated content and/or the like. Providing such goal and/or ambiance descriptions may increase the user's chances of encountering items in the electronic game associated with identified positive sentiment subjects. Content composer 234 may provide input terms that feed only a limited subset of filters such as for electronic game places or goals.

In one example, content source generator 210 may personalize an electronic game in a variety of ways. For example, content composer 234 may search electronic game assets using datacenter search capabilities to identify electronic game assets that may be associated with extracted feed content. Content composer 234 may send a listing of electronic game assets and associated extracted feed content to content source generator 210. Such a system can result in a player effectively “playing their interests” by encountering a number of adventures related to their preferred reading topics. For example, a “car guy” may have adventures filled with notable vehicles and get to see seldom used parts of the automotive model selection while a person who follows discussions on high fantasy may run into giants and elves in a customized electronic game based on extracted feed content.

In one example, selecting positive and/or relevant electronic game assets to personalize an electronic game associated with the particular user may increase the likelihood of presenting a positive user experience to the particular user. CSG center 104 may send or identify the selected positive electronic game assets and relevant electronic game content to a game engine 102 for assembly and display of the modified electronic game associated with the particular user.

In one example, a particular user may also access email and/or content feeds from within an electronic game environment because content source 140 may be in communication with an electronic game module. Thus, users may access email or read feeds while in-game.

In one example, a user may manually and/or automatically remove and/or add content for analysis in system 200. The inclusion of weather feeds, for example from the user's RSS feedlist or even by synthetically and deliberately adding a weather feed for a user's detected location to the input of feed connection 230 may increase the possibility of matching ambiance to the user's real-world ambiance, thus subtly increasing immersion. Once subject and feed inputs are available a whole host of other content mechanisms become possible. Game world news may be connected to the feed connection 230 so that merely posting a game news item about an orc invasion would increase the likelihood of players running into ores, without needing any developer time to manually stage the event.

The concept of what is “positive” and what is “negative” varies depending on the category of electronic game asset. What is positive in one electronic game category may be negative in another. For example, a bird enthusiast may return positive sentiment toward avian words and this may increase the likelihood that allies are likely to be bird-themed. However, enemies perhaps should not be bird-themed. Thus, for a category of enemies in this case, sentiment related to birds may be classified as negative. Positive and negative subject associations and searches may be modified depending on electronic game asset categories.

In one example, when multiple players get together such as in an MMOG, system 200 may pool positive subjects and negative subjects, raising weights on those encountered frequently among multiple players (for example by adding the weights of individual users together for each subject).

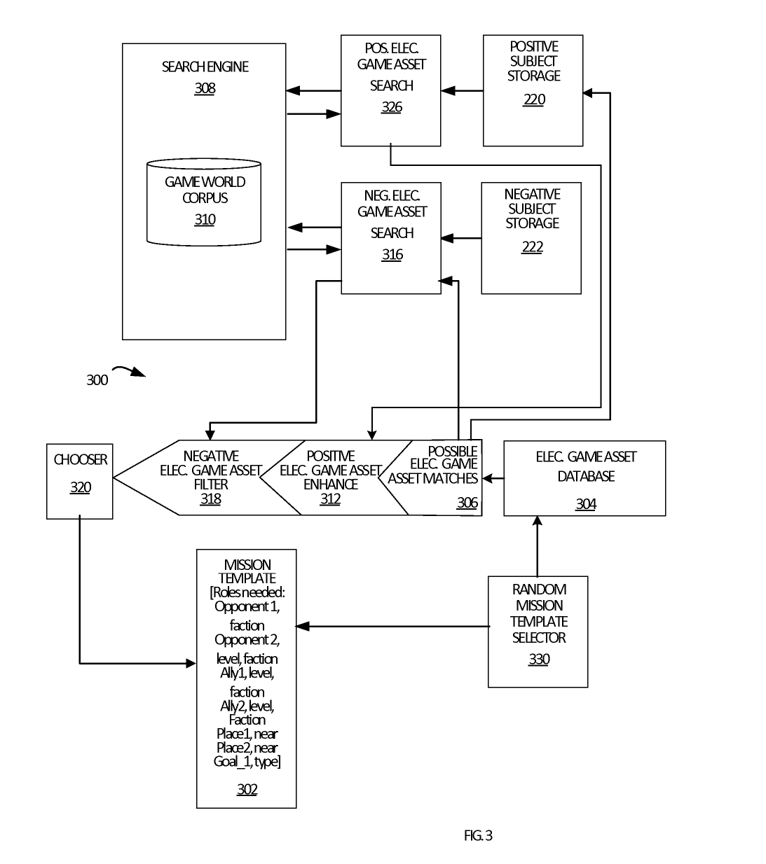

FIG. 3 is a block diagram illustrating an example system 300 that can be utilized to personalize an electronic game, arranged in accordance with at least some embodiments described herein. As depicted, system 300 may comprise, electronic game procedural content generation that may operate on a fill-in-the-blanks model. For example, quest or mission systems may first pick a template that has blank electronic game assets to be filled and then select electronic game assets to fill those roles based on specific qualities. Some electronic game assets may include opponents, allies, goals and/or locations.

In one example, a template selector may pick a template such as “Player will navigate to <2 places>, face <2 opponents>, work with <1 ally> and achieve <1 goal>” where each of the roles of places, opponents, allies, and goals may have labels and/or levels of difficulties associated with them.

In one example, using the Python programming language, a call to a function that picks a random adventure template may return a dictionary containing a key for each role that needs to be filled and labels relative to a database label set that is information for filling that role (e.g. in a tuple). An example of such a structure may look like the following:

In [11]:Roles_Needed
Out[11]:
{‘ally_1’: (‘level’, ‘faction’),
‘goal_1’: ‘type’,
‘near’: ‘special’,
‘opponent_1’: (‘level’, ‘faction’),
‘opponent_2’: (‘level’, ‘faction’),
‘place_1’: ‘special’}

The word ‘level’ may denote challenge or power ratings (e.g. an integer from 1 to 100) and ‘faction’ relates to representation of the group or general allegiance needed to fill the role (e.g. “evil” opponents and “good” allies for a “good” player and vice versa). Once the list of roles (or an iterator that presents roles to fill) is ready, each role is then filled from a relevant game database.

In one example, the electronic game may be personalized based on negative and/or positive sentiment analysis of intercepted content associated with a particular user. Positive and/or negative subjects may be identified as discussed above with reference to FIG. 1 and FIG. 2. A random/procedural mission template selector 330 may be configured to generate a mission template module 302 that may include blank electronic game assets.

In one example, the electronic game assets comprise roles that are to be filled including opponents, allies, places, goals and/or the like. For each of these roles the details (e.g. ‘opponent_{—}1’: (‘level 5’, ‘faction evil’) may be sent as a request to the relevant database, e.g. the electronic game asset database 304, which may output possible electronic game matches 306 based on the labels (e.g., level and faction). Positive subjects in positive subject storage 220 may be combined with possible electronic game asset matches in positive electronic game asset search module 326 and run through a search engine 308 configured to search over a game world corpus 310 including a variety of electronic game related subjects and content such as, game flavor text, fiction, blogs, advertisements, web sites and/or the like about the game world. This may be accomplished by searching for the relevance of each possible positive subject and/or possible role match.

In one example, search engine 308 may output a correlation matrix in a parallelized fashion corresponding to the positive subjects and possible electronic game asset matches 306. Such a matrix may enable detection of a relationship strength between possible electronic game asset matches 306 and positive subjects. For example, a possible “place” match “castle” may be associated with a positive subject “stormy weather” based on search results indicating that the electronic game castle is pictured in stormy weather.

In one example, an output of the search may be communicated to positive electronic game asset enhancement module 312 wherein a probability of more related items may be increased, for example, by increasing the population if chooser 320 will pick randomly, by deleting unrelated items, and/or by increasing a weight associated with possible electronic game asset matches 306.

In one example, a correlation may be determined between possible electronic game asset matches 306 and the negative subjects at negative electronic game asset search 316. Negative subjects from negative subject storage 222 may be combined with possible electronic game asset matches 306 and run through search engine 308. An output of negative electronic game asset search 316 is sent to negative electronic game asset filter 318 where electronic game assets (e.g., roles) associated with negative subjects may be removed from a set of possible electronic game assets. For example, all “plague creatures” may be removed from possible electronic game asset matches 306 where a negative subject such as “sickness” is associated with a particular player with whom the electronic game is associated. A chooser 320 may receive and select from filtered possible matches one or more electronic game asset options. Chooser 320 may send the results to mission template module 302 to populate the mission template module 302.

In one example, un-curated user content in game world corpus 310 (such as a game wiki) may be excluded from a search to correlate negative and/or positive subjects with possible role matches or other matching to electronic game assets. This may prevent players from manipulating the system for personalizing electronic game content. For example, unchecked players may insert a non-word into a creature wiki entry and also their emails to cause search engine 308 to return pre-determined modification results. An implementation may include a statistical tracking signal of users who have unexpectedly many or strong “high correlation matches.” A deterrent may be disabling system 300 if a particular “high correlation matches” threshold is surpassed.

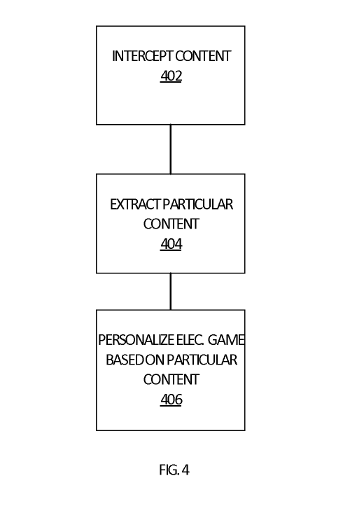

FIG. 4 is a flow diagram illustrating an example of a process 400 that can be utilized to personalize an electronic game, arranged in accordance with at least some embodiments described herein. As depicted, process 400 may start at operation 402, where content may be intercepted from a content source. The content source may comprise any of a variety of content sources such as email and/or RSS feed text or social network content. Process 400 may move to operation 404 where particular content may be extracted from the intercepted content. Extracting particular content may comprise extracting words from text based content using at least one of terminology extraction, terminology mining, term extraction, term recognition, or glossary extraction. In an example, extracted words may be related to at least one of sentiments, entities, relations, locations, emotions, or associations. Process 400 may proceed to operation 406 where an electronic game may be personalized based on the extracted content. In an example, the electronic game may be personalized based on particular words extracted from the intercepted content. Personalizing an electronic game may comprise personalizing an online game, video game and/or a massively multiplayer online game (MMOG). Personalizing an electronic game may comprise personalizing an environment of an electronic game such as scenery, background, character, mood or interaction of the electronic game.

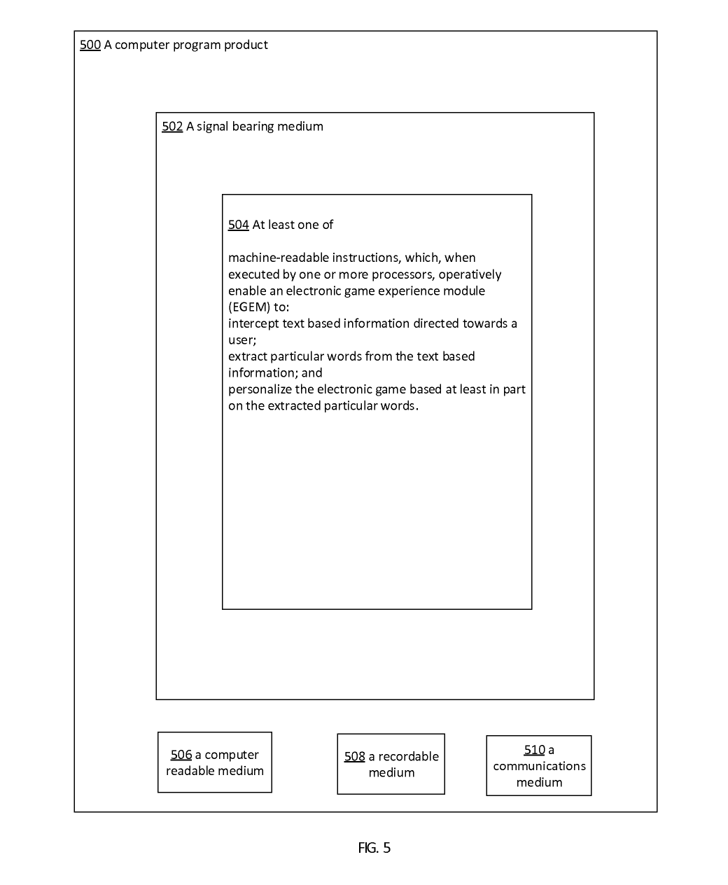

FIG. 5 is a block diagram illustrating one example of a computer program product 500, arranged in accordance with at least some embodiments described herein. As depicted, computer program product 500 may include machine-readable non-transitory medium having stored therein a plurality of instructions that, when executed, operatively enable an electronic game experience module to intercept and extract content to be utilized to personalize an electronic game according to the processes and methods discussed herein. Computer program product 500 may include a signal bearing medium 502. Signal bearing medium 502 may include one or more machine-readable instructions 504, which, when executed by one or more processors, may operatively enable a computing device to provide the functionality described herein. In various examples, the devices discussed herein may use some or all of the machine-readable instructions.

In one example, the machine-readable instructions 504 may include intercepting text based information directed towards a user. In some examples, the machine-readable instructions 504 may include extracting particular words from the text based information. In some examples, machine-readable instructions 504 may include personalizing the electronic game based at least in part on the extracted particular words.

In one example, signal bearing medium 502 may encompass a computer-readable medium 506, such as, but not limited to, a hard disk drive, a Compact Disc (CD), a Digital Versatile Disk (DVD), a digital tape, memory, etc. In some implementations, signal bearing medium 502 may encompass a recordable medium 508, such as, but not limited to, memory, read/write (R/W) CDs, R/W DVDs, etc. In some implementations, signal bearing medium 502 may encompass a communications medium 510, such as, but not limited to, a digital and/or an analog communication medium (e.g., a fiber optic cable, a waveguide, a wired communication link, a wireless communication link, etc.). In some examples, signal bearing medium 502 may encompass a machine readable non-transitory medium.

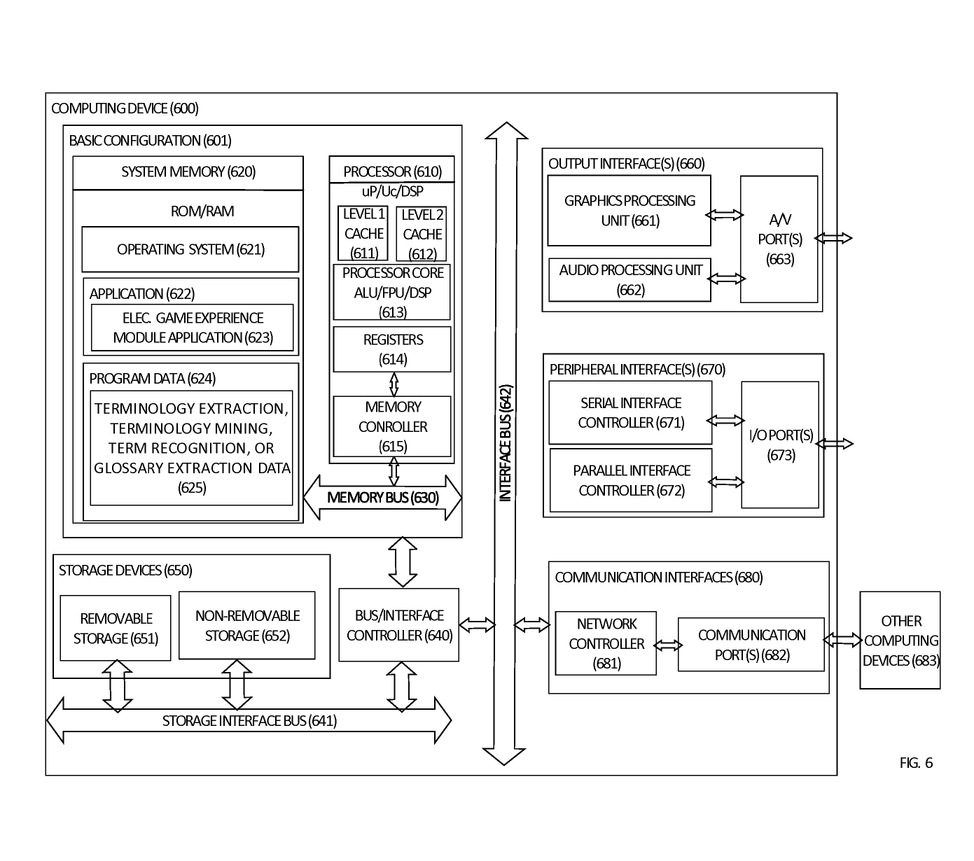

In general, the method described with respect to FIGS. 1-5, and elsewhere herein may be implemented in any suitable server and/or computing system. Example systems may be described with respect to FIG. 6 and elsewhere herein. In general, the computer system may be configured to intercept and extract content to be utilized to personalize an electronic game.

FIG. 6 is a block diagram illustrating an example of a computing device 600, arranged in accordance with at least some embodiments of the present disclosure. In various examples, computing device 600 may be configured to facilitate intercepting and extracting content to be utilized to personalize an electronic game discussed herein. In one example of a basic configuration 601, computing device 600 may include one or more processors 610 and a system memory 620. A memory bus 630 can be used for communicating between one or more processors 610 and system memory 620.

Depending on the desired configuration, one or more processors 610 may be of any type including but not limited to a microprocessor (μP), a microcontroller (μC), a digital signal processor (DSP), or any combination thereof. One or more processors 610 may include one or more levels of caching, such as a level one cache 611 and a level two cache 612, a processor core 613, and registers 614. Processor core 613 can include an arithmetic logic unit (ALU), a floating point unit (FPU), a digital signal processing core (DSP Core), or any combination thereof. A memory controller 615 can also be used with one or more processors 610, or in some implementations memory controller 615 can be an internal part of processor 610.

Depending on the desired configuration, system memory 620 may be of any type including but not limited to volatile memory (such as RAM), non-volatile memory (such as ROM, flash memory, etc.) or any combination thereof. System memory 620 may include an operating system 621, one or more applications 622, and program data 624. one or more applications 622 may include an electronic game experience module application 623 that can be arranged to perform the functions, actions, and/or operations as described herein including the functional blocks, actions, and/or operations for intercepting and extracting content to be utilized to personalize an electronic game as described herein. Program data 624 may include, among other data, sentiment, entity, relation, location, emotion, or association data 625 or the like for use with electronic game experience module application 623, as described herein. In some example embodiments, one or more applications 622 may be arranged to operate with program data 624 on operating system 621. This described basic configuration 601 is illustrated in FIG. 6 by those components within dashed line.

The computing device 600 may have additional features or functionality, and additional interfaces to facilitate communications between basic configuration 601 and any required devices and interfaces. For example, a bus/interface controller 640 may be used to facilitate communications between basic configuration 601 and one or more data storage devices 650 via a storage interface bus 641. One or more data storage devices 650 may be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data. System memory 620, removable storage 651 and non-removable storage 652 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

The computing device 600 may also include an interface bus 642 for facilitating communication from various interface devices (e.g., output interfaces, peripheral interfaces, and communication interfaces) to basic configuration 601 via bus/interface controller 640. Example output interfaces 660 may include a graphics processing unit 661 and an audio processing unit 662, which may be configured to communicate to various external devices such as a display or speakers via one or more A/V ports 663. Example peripheral interfaces 670 may include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which may be arranged to facilitate communications with one or more other computing devices 683 over a network communication via one or more communication ports 682. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 600 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. In addition, computing device 600 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to subject matter containing only one such recitation, even when the same claim includes the introductory phrases one or more or at least one and indefinite articles such as “a” or an (e.g., “a” and/or an should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an example,” “one example,” “some examples,” or “other examples” may mean that a particular feature, structure, or characteristic described in connection with one or more examples may be included in at least some examples, but not necessarily in all examples. The various appearances of “an example,” “one example,” or “some examples” in the preceding description are not necessarily all referring to the same example.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for personalizing an electronic game, the method comprising:
intercepting text based information directed towards a user;
extracting particular words from the text based information; and
personalizing the electronic game based at least in part on the extracted particular words.

2. The method of claim 1, wherein intercepting the text based information comprises intercepting an email.

3. The method of claim 1, wherein intercepting the text based information comprises intercepting a rich site summary (RSS) feed.

4. The method of claim 1, wherein extracting particular words comprises extracting using at least one of terminology extraction, terminology mining, term extraction, term recognition, or glossary extraction.

5. The method of claim 1, wherein extracting particular words comprises extracting particular words related to at least one of sentiments, entities, relations, locations, emotions, or associations.

6. The method of claim 1, wherein personalizing the electronic game comprises personalizing a massively multiplayer electronic game.

7. The method of claim 1, wherein personalizing the electronic game comprises personalizing an environment of the electronic game.

8. The method of claim 7, wherein personalizing the environment comprises personalizing at least one of scenery, background, character, mood, or interaction of the electronic game.

9. A machine readable non-transitory medium having stored therein instructions that, when executed by one or more processors, operatively enable an electronic game experience module (EGEM) to:
intercept text based information directed towards a user;
extract particular words from the text based information; and
personalize the electronic game based at least in part on the extracted particular words.

10. The machine readable non-transitory medium of claim 9, wherein the stored instructions that operatively enable the EGEM to intercept text based information include instructions that, when executed by one or more processors, operatively enable the EGEM to intercept an email.

11. The machine readable non-transitory medium of claim 9, wherein the stored instructions that operatively enable the EGEM to intercept text based information include instructions that, when executed by one or more processors, operatively enable the EGEM to intercept a rich site summary (RSS) feed.

12. The machine readable non-transitory medium of claim 9, wherein the stored instructions that operatively enable the EGEM to extract particular words include instructions that, when executed by one or more processors, operatively enable the EGEM to extract using at least one of terminology extraction, terminology mining, term extraction, term recognition, or glossary extraction.

13. The machine readable non-transitory medium of claim 9, wherein the stored instructions that operatively enable the EGEM to extract particular words include instructions that, when executed by one or more processors, operatively enable the EGEM to extract particular words related to at least one of sentiments, entities, relations, locations, emotions, or associations.

14. The machine readable non-transitory medium of claim 9, wherein the stored instructions that operatively enable the EGEM to personalize the electronic game include instructions that, when executed by one or more processors, operatively enable the EGEM to personalize a massively multiplayer electronic game.

15. The machine readable non-transitory medium of claim 9, wherein the stored instructions that operatively enable the EGEM to personalize the electronic game include instructions that, when executed by one or more processors, operatively enable the EGEM to personalize an environment of the electronic game.

16. The machine readable non-transitory medium of claim 15, wherein the stored instructions that operatively enable the EGEM to personalize the electronic game include instructions that, when executed by one or more processors, further operatively enable the EGEM to personalize at least one of scenery, background, character, mood, or interaction of the electronic game.

17. A system to personalize an electronic game comprising:
a processor;
an electronic game experience module (EGEM) communicatively coupled to the processor, the EGEM configured to:
intercept text based information directed towards a user;
extract particular words from the text based information; and
personalize the electronic game based at least in part on the extracted particular words.

18. The system of claim 17, wherein to intercept text based information, the EGEM is configured to intercept an email.

19. The system of claim 17, wherein to extract particular words from the text based information, the EGEM is configured to intercept a rich site summary (RSS) feed.

20. The system of claim 17, wherein to extract particular words from the text based information, the EGEM is configured to extract using at least one of terminology extraction, terminology mining, term extraction, term recognition, or glossary extraction.

21. The system of claim 17, wherein to extract particular words from the text based information, the EGEM is configured to extract particular words related to at least one of sentiments, entities, relations, locations, emotions, or associations.

22. The system of claim 17, wherein to personalize the electronic game based at least in part on the extracted particular words, the EGEM is configured to personalize a massively multiplayer electronic game.

23. The system of claim 17, wherein to personalize the electronic game based at least in part on the extracted particular words, the EGEM is configured to personalize an environment of the electronic game.

24. The system of claim 23, wherein to personalize the electronic game based at least in part on the extracted particular words, the EGEM is further configured to personalize at least one of scenery, background, character, mood, or interaction of the electronic game.
